(19) United States
(12) Patent Application Publication
(10) Pub. No.: US 2007/0120556 A1
(43) Pub. Date: May 31, 2007

(54) MAGNETIC POSITION SENSOR FOR A MOBILE OBJECT WITH LIMITED LINEAR TRAVEL

(75) Inventors: Laurent DUFOUR, Meximieux (FR); Bertrand LEGRAND, Grenoble (FR)

Correspondence Address: DENNISON, SCHULTZ & MACDONALD, 1727 KING STREET, SUITE 105, ALEXANDRIA, VA, 22314, US

(73) Assignee: ELECTRICFIL AUTOMOTIVE, Miribel (FR)

(21) Appl. No.: 11/563,295

(22) Filed: Nov. 27, 2006

(30) Foreign Application Priority Data
Nov. 29, 2005 (FR) 05 12 053

(51) Int. Cl. G01B 7/14

(52) U.S. Cl. 324/207.24

(57) ABSTRACT

A magnetic sensor including a first resource (3) for the creation of a magnetic field, oriented along a first axis in the direction of the axis of movement, and a second resource (6) for the creation of a magnetic field, oriented along a second axis in the direction of the axis of movement, opposed to the first direction. The first and second field-creation resources are mounted opposite to each other in order to form, between them, a magnetic measuring gap in which the measuring element that is sensitive to the value of the magnetic flux generated by the first and second field-creation resources is located, with the measuring element or the first and second field-creation resources being linked to the mobile object.

### BACKGROUND OF THE INVENTION

This present invention concerns the technical area of no-contact magnetic sensors, designed to ascertain the position of a mobile object moving along a linear axis of motion.

The subject of the invention finds a particularly advantageous, though not exclusive, application in the area of motor vehicles, with a view to equipping different devices with limited linear travel whose position must be known, and forming part, in particular, of an electric braking arrangement for motor vehicles.

In previous designs, there are many types of no-contact sensors, designed to ascertain the linear position of a mobile object moving in translation. For example, we are thus familiar with a sensor of the optical type whose major drawback concerns its cost of production. By virtue of its design, a sensor of eddy-current or of the coil type is very bulky, and this limits its applications.

We are also familiar with sensors of the magnetic type that include a magnet creating a magnetic field and a measuring element that is sensitive to the value of the magnetic flux generated by the magnet. The measuring element, such as a Hall-effect probe, is designed to measure variations in the value of the magnetic flux resulting from the relative motion between the magnet and the measuring element. The measured variations in the value of the magnetic flux are used to determine the linear position of a mobile object linked to the magnet or to the measuring element.

This type of magnetic sensor has the disadvantage of not being able to effect detection at a magnetic flux value of zero gauss, which leads to errors in the measurements effected. In addition, it turns out that such a magnetic sensor has a non-linear response, with a small dynamic range, with the consequent adverse impact on its detection quality.

### SUMMARY OF THE INVENTION

The subject of this present invention therefore aims to remedy the aforementioned drawbacks, by proposing a no-contact magnetic sensor, designed to determine the position of a mobile object moving along a limited linear distance, and that is of simple design, economic, small in size and able to operate at zero gauss, with a linear range of variation of the magnetic flux that is relatively large.

In order to attain this objective, the magnetic sensor includes:
a first resource for the creation of a magnetic field, oriented along a first axis in the direction of the axis of movement,
and a second resource for the creation of a magnetic field, oriented along a second axis in the direction of the axis of movement, opposite to the first direction, where the first and second field-creation resources are mounted opposite to each other in order to form, between them, a magnetic measuring gap in which the measuring element that is sensitive to the value of the magnetic flux generated by the first and second field-creation resources is located, with the measuring element or the first and second field-creation resources being linked to the mobile object.

According to a preferred implementation variant, the first and second field-creation resources take the form of magnets mounted in magnetic opposition in relation to each other.

Advantageously, the magnets are associated with a magnetic circuit.

According to the invention, the measuring element is a cell which is mounted so as to be sensitive to a magnetic field that is oriented in the direction of motion.

According to an implementation variant, the measuring element is linked to the mobile object.

According to another implementation variant, the first and second field-creation resources are linked to the mobile object.

Another purpose of the invention is to propose an electric braking device or arrangement, in particular for a motor vehicle, with at least one magnetic sensor according to the invention.

### BRIEF DESCRIPTION OF THE DRAWINGS

Various other characteristics will emerge from the description that follows, with reference to the appended drawings which, by way of non-limiting examples, show different forms of implementation of the subject of the invention.

FIG. 1 is a schematic view of a first example of implementation of a magnetic position sensor according to the invention.

FIG. 2 is a schematic view of a second example of implementation of a magnetic position sensor according to the invention.

### DESCRIPTION OF THE PREFERRED EMBODIMENTS

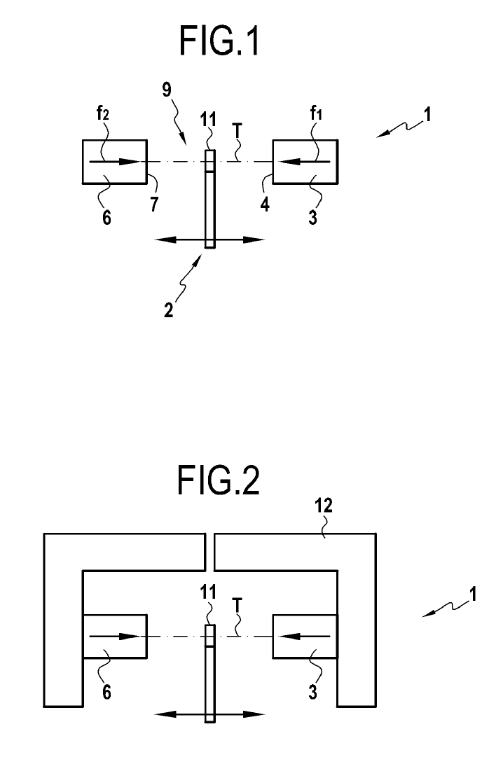

As can be seen more precisely in FIG. 1, the subject of the invention concerns a magnetic sensor 1 designed to determine the position of a mobile object 2, in the general sense, moving along an axis or a direction of motion T. The mobile object 2 represents any type of device with linear travel, forming part, preferably but not exclusively, of a device fitted to a motor vehicle, and preferably an electric braking device or arrangement in a motor vehicle.

The magnetic sensor 1 includes a first resource 3 for the creation of a magnetic field, oriented along a first axis in the direction of the axis of movement T, represented by arrow f₁. In a preferred implementation variant, this first resource 3 for the creation of a magnetic field is composed of a magnet presenting a polar face 4 lying in a plane approximately perpendicular to the direction of motion T.

The sensor 1 according to the invention includes a second resource 6 for the creation of a magnetic field, oriented along a second axis in the direction of the axis of movement, oppose to the first direction f₁ and represented by arrow f₂. In a preferred implementation variant, the second resource 6 for the creation of a magnetic field takes the form of a magnet presenting a polar face 7 lying in a plane approximately perpendicular to the direction of motion T.

The magnets 3 and 6 are mounted opposite to each other, and in magnetic opposition to each other, with a view to forming a magnetic measuring gap 9 between their opposing pole faces 4, 7. The magnets 3, 6 thus generate magnetic flux oriented along the same axis, but in opposite directions. In the example illustrated, the magnetic flux comes out of the magnets 3, 6. Naturally, the magnets 3, 6 can be mounted in a reversed orientation, so that the magnetic flux can be considered to be entering into the pole faces 4, 7.

The magnetic sensor 1 also includes, a measuring element 11, intended to be mounted in the magnetic gap 9. This measuring element 11 is sensitive to the value of the magnetic flux generated by the magnets 3, 6. The measuring element 11 is mounted in the magnetic gap 9 in order be sensitive to the magnetic fields oriented in the direction of motion T. Such a measuring element can be composed of a Hall-effect cell for example.

The measuring element 11 or the magnets 3, 6 are linked to the mobile object 2. In the example illustrated, the measuring element 11 is linked to the mobile object 2, so that the measuring element 11 moves along the axis T between the pole faces 4, 7 of the magnets 3, 6, which are fixed. Naturally, it can also be envisaged that the mobile object 2 is linked to the magnets 3, 6, so that the measuring element 11 is fixed.

It should be understood that the measuring element 11 is designed to measure the value of the magnetic flux generated by the magnets 3, 6 and/or the variations in the value of the magnetic flux generated by the magnets 3, 6. The value of the magnetic flux measured by the measuring element 11 thus varies as a function of the relative motion between the measuring element 11 and the magnets 3, 6, thus allowing the linear position of the mobile object along the axis of motion to be determined.

The output signal delivered by the measuring element 11 is transmitted to signal processing resources (not shown, but known in themselves) which are used to determine the linear position of the mobile object 2 along the axis of movement T.

Such a measuring sensor has the special feature of allowing measurements of the value of the magnetic field close to or centred on magnetic zero, while also having a high detection gradient. Such a measuring sensor has no hysteresis, and no sensitivity in the plane perpendicular to the axis of movement T.

FIG. 2 shows an example of implementation in which the magnets 3, 6 are associated with a magnetic circuit 12 of any type known in its own right. In the example illustrated, the magnetic circuit is U-shaped, formed by inverted-L-shaped pole pieces and fitted with the two magnets 3. According to FIG. 2, the magnetic circuit formed is open. Naturally, it is also possible to make a magnetic circuit 12 that is closed in two or three dimensions.

The invention is not limited to the examples described and represented, since various changes can be made to it without moving outside the scope of the invention.

What is claimed is:

1. A magnetic sensor to determine the position of a mobile object with a limited linear travel along an axis of movement, where the sensor includes a measuring element (11) that is sensitive to the value of a magnetic flux, and designed to measure the value, and/or the variations in value, of the magnetic flux, so as to determine the linear position of the mobile object along the axis of movement, the sensor comprising:
a first resource (3) for the creation of a magnetic field oriented along a first axis in the direction of the axis of movement, and
a second (6) resource for the creation of a magnetic field oriented along a second axis in the direction of the axis of movement, opposite to the first direction, with the first and second field-creation resources being mounted opposite to each other in order to form, between them, a magnetic measuring gap in which the measuring element that is sensitive to the value of the magnetic flux generated by the first and second field-creation resources is located, with the measuring element or the first and second field-creation resources being linked to the mobile object.

2. A magnetic sensor according to claim 1, wherein the first (3) and second (6) field-creation resources take the form of magnets mounted in magnetic opposition in relation to each other.

3. A magnetic sensor according to claim 2, wherein the magnets (3, 6) are associated with a magnetic circuit (12).

4. A magnetic sensor according to claim 1, wherein the measuring element (11) is a cell which is mounted so as to be sensitive to a magnetic field that is oriented along the axis of movement (T).

5. A magnetic sensor according to claim 1, wherein the measuring element (11) is linked to the mobile object.

6. A magnetic sensor according to claim 1, wherein the first and second field-creation resources (3, 6) are linked to the mobile object.

7. An electric braking device for a motor vehicle, including at least one magnetic sensor (1) according to claim 1.
